(19) United States
(12) Patent Application Publication
(10) Pub. No.: US 2015/0048226 A1
(43) Pub. Date: Feb. 19, 2015

(54) MOUNTING DEVICE FOR EXPANSION CARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: LI-REN FU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/014,398

(22) Filed: Aug. 30, 2013

(30) Foreign Application Priority Data
Aug. 19, 2013 (CN) 2013103603788

(51) Int. Cl. G06F 1/18; F16M 13/02

(52) U.S. Cl. CPC G06F 1/185; F16M 13/02
USPC 248/222.11

(57) ABSTRACT

A mounting device for fixing an expansion card to a circuit board includes a fixing member and a latching member. Each of the fixing member and the latching member includes a supporting portion sandwiched between the circuit board and the expansion card, a post extending from the supporting portion extending through the expansion card, and a projection abutting a top surface of the expansion card.

### BACKGROUND

1. Technical Field

The present disclosure relates to a mounting device for fixing an expansion card.

2. Description of Related Art

Expansion cards parallel to motherboards are often mounted to the motherboards by screws to ensure secure mounting, which is time consuming in installing or uninstalling the expansion cards.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting device, together with a circuit board and an expansion card.

FIG. 2 is an assembled, isometric view of FIG. 1.

FIG. 3 is a side plan view of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

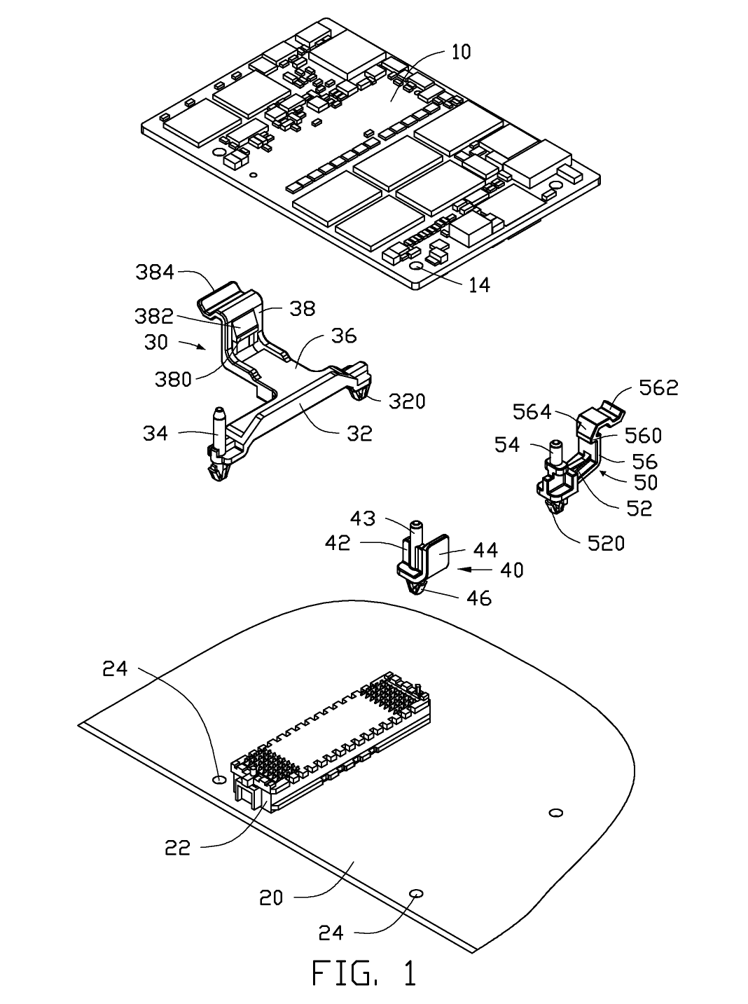

FIG. 1 is an embodiment of a mounting device. The mounting device is provided for fixing an expansion card 10 to a circuit board 20. The mounting device includes a latching member 30, a supporting member 40, and a fixing member 50.

A socket 22 is mounted on the circuit board 20. The circuit board 20 defines two through holes 24 adjacent to each of opposite sides of the socket 22.

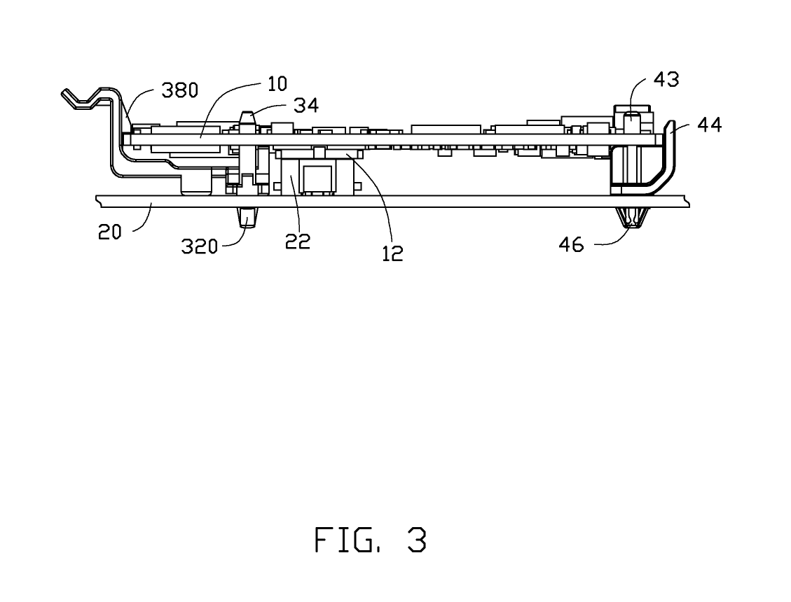

The expansion card 10 includes a connector 12 located at a bottom surface (shown in FIG. 3), and defines three installing holes 14.

The latching member 30 includes a supporting portion 32, a post 34 extending up from the supporting portion 32, an extension portion 36 extending rearward from the supporting portion 32, and a blocking portion 38 extending up from a rear end of the extension portion 36. A wedge-shaped projection 380 protrudes from a front side of the blocking portion 38. A top surface 382 of the projection 380 slantingly extends down and toward the supporting portion 32. An operation portion 384 extends rearward from a top end of the blocking portion 38. The latching member 30 includes two tapered pliable legs 320 on a bottom of the supporting portion 32.

The supporting member 40 includes a supporting portion 42, a post 43 extending up from the supporting portion 42, and a blocking piece 44 extending up from a front end of the supporting portion 42. The supporting member 40 includes a leg 46 on a bottom of the supporting portion 42. The leg 46 is as same as the legs 320.

The fixing member 50 includes a supporting portion 52, a post 54 extending up from the supporting portion 42, and a blocking portion 56 extending up from an end of the supporting portion 42. The blocking portion 56 has a same form as the blocking portion 38. A projection 560 same as the projection 380 protrudes from a side of the blocking portion 56 facing the supporting portion 52. An operation portion 562 same as the operation portion 384 extends from a top end of the blocking portion 56 and away from the supporting portion 52. A top surface 564 of the projection 560 slantingly extends down and toward the supporting portion 52. The fixing member 50 includes a leg 520 on a bottom of the supporting portion 52. The leg 520 is the same as the legs 320.

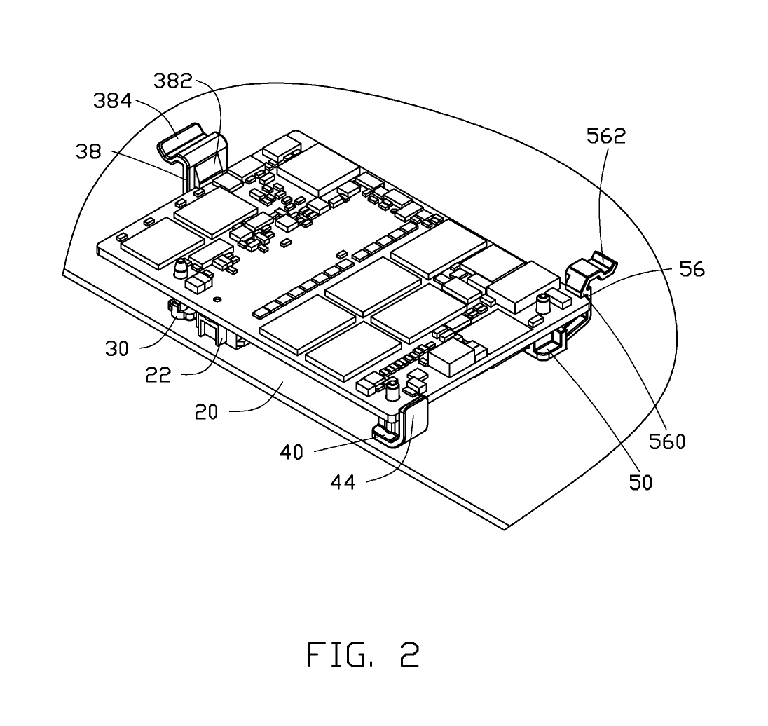

FIGS. 2 and 3 show that in assembly, the legs 320 are deformed and extended through the through holes 24 behind the socket 22. The legs 46 and 520 are deformed and extended through the through holes 24 in front of the socket 22, until the supporting portions 32, 42, and 52 contact a top surface of the circuit board 20. The legs 320, 46, and 520 are then restored and are abutted a bottom surface of the circuit board 20, thereby fixing the latching member 30, the supporting member 40, and the fixing member 50 on the circuit board 20. The blocking portion 56 is away from the supporting member 40, with the projection 560 facing the post 43.

In use, the expansion card 10 is positioned among the latching member 30, the supporting member 40, and the fixing member 50, with a rear end and a side of the expansion card 10 contact the top ends of the top surfaces 382 and 564, allowing the expansion card 10 to be parallel to the circuit board 20. The expansion card 10 is then pushed toward the circuit board 20, to deform the blocking portions 38 and 56 away from the expansion card 10. The posts 34, 43, and 54 are extended through the installing holes 14, and the connector 12 is electrically engaged in the socket 22, until the expansion card 10 is placed on the supporting portions 32, 42, and 52. At this time, the blocking portions 38 and 56 are restored to allow the projections 380 and 560 to abut a top surface of the expansion card 10. The rear end of the expansion card 10 abuts the blocking portion 38. A front end of the expansion card 10 abuts the blocking piece 44. The side of the expansion card 10 abuts the blocking portion 56.

In uninstalling the expansion card 10, the blocking portions 38 and 56 are deformed away from the expansion card 10, to allow the projections 380 and 560 to disengage from the expansion card 10.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting an expansion card to a circuit board, comprising:
a latching member and a fixing member; each of the latching member and the fixing member comprising a supporting portion to be mounted on the circuit board to support the expansion card, a post extending up from the supporting portion to extend through the expansion card, and a projection connected to the supporting portion to abut a top surface of the expansion card.

2. The mounting device of claim 1, wherein a top surface of each projection slantingly extends down and toward the corresponding supporting portion.

3. The mounting device of claim 1, wherein two blocking portions extend up from the supporting portions to abut an end and a side of the expansion card, respectively, the projections protrude from the blocking portions.

4. The mounting device of claim 3, wherein an operation portion extends away from the corresponding projection from each blocking portion.

5. The mounting device of claim 3, further comprising a supporting member comprising a supporting portion mounted on the circuit board to support the expansion card, a post extending up from the supporting portion of the supporting member to extend through the expansion card, and a blocking piece extending up from the supporting portion of the supporting member to abut another end of the expansion card.

6. The mounting device of claim 5, wherein a pliable leg is formed on a bottom of each supporting portion to extend through the circuit board and abut a bottom of the circuit board.
